(19) United States
(12) Patent Application Publication
(10) Pub. No.: US 2026/0281388 A1
(43) Pub. Date: Sep. 17, 2026

(54) DEVICE AND METHOD FOR DECODING VIDEO DATA

(71) Applicant: SHARP KABUSHIKI KAISHA, Sakai City, Osaka (JP)

(72) Inventors: CHIH-YU TENG, Taipei (TW); YU-CHIAO YANG, Taipei (TW)

(21) Appl. No.: 19/166,727

(22) PCT Filed: Mar. 19, 2024
(86) PCT No.: PCT/CN2024/082485

§ 371 Date: Sep. 18, 2025

Related U.S. Application Data
(60) Provisional application No. 63/453,450, filed on Mar. 20, 2023.

(51) Int. Cl. H04N 19/176; H04N 19/105; H04N 19/159; H04N 19/192; H04N 19/70

(52) U.S. Cl. CPC H04N 19/176; H04N 19/105; H04N 19/159; H04N 19/192; H04N 19/70

(57) ABSTRACT

A method of decoding video data performed by an electronic device is provided. The method receives the video data and determines a chroma current block from a current frame included in the video data. The method further determines a luma corresponding block reconstructed based on a luma reference block, and determines a chroma reference block based on a luma block vector of the luma corresponding block. The luma corresponding block is determined based on a luma current block collocated with the chroma current block, and the luma block vector of the luma corresponding block directs from the luma corresponding block towards the luma reference block. The method derives a chroma prediction model of the chroma current block based on the chroma reference block, and reconstructs the chroma current block based on the chroma prediction model of the chroma current block.

### CROSS-REFERENCE TO RELATED APPLICATION(S)

The present disclosure claims the benefit of and priority to U.S. Provisional Patent Application Ser. No. 63/453,450, filed on Mar. 20, 2023, entitled “PROPOSED CHROMA PREDICTION WITH INTRA TEMPLATE MATCHING METHOD,” the content of which is hereby incorporated herein fully by reference in its entirety for all purposes.

### FIELD

The present disclosure generally relates to video coding, and more specifically, to techniques for predicting a chroma current block in a current frame based on a luma corresponding block in the current frame.

### BACKGROUND

Linear model prediction is a coding tool for video coding, in which an encoder and a decoder may use the previously reconstructed pixels adjacent to a block unit and included in one predefined reference region to estimate a prediction model equation of a prediction model mode for predicting or reconstructing several chroma pixels of the block unit based on several reconstructed luma pixels of the block unit.

When the encoder and the decoder calculate the prediction model equation, they try to calculate several prediction model parameters of the linear model equation merely based on the previously reconstructed pixels adjacent to the block unit. However, the reconstructed adjacent pixels may be inadequate to predict all of the block units in the video. In addition, the decoding efficiency may be low when the reference pixels of the linear model equation can be only included in a predefined neighboring region.

Therefore, different kinds of prediction model modes may be required for the encoder and the decoder to be able to precisely and efficiently predict and/or reconstruct the chroma pixels.

### SUMMARY

The present disclosure is directed to a device and method for predicting a chroma current block in a current frame based on a luma corresponding block in the current frame.

In a first aspect of the present disclosure, a method of decoding video data and an electronic device for performing the method are provided. The electronic device includes one or more processors; and one or more non-transitory computer-readable media coupled to the one or more processors and storing one or more computer-executable instructions that, when executed by at least one of the one or more processors, cause the at least one of the one or more processors to perform the method. The method includes receiving the video data; receiving the video data; determining a chroma current block from a current frame included in the video data; determining a luma corresponding block reconstructed based on a luma reference block, wherein: the luma corresponding block and the luma reference block are included in the current frame and reconstructed prior to reconstructing the chroma current block, and the luma corresponding block is determined based on a luma current block collocated with the chroma current block, determining a chroma reference block based on a luma block vector of the luma corresponding block, wherein the luma block vector of the luma corresponding block directs from the luma corresponding block towards the luma reference block; deriving a chroma prediction model of the chroma current block based on the chroma reference block; and reconstructing the chroma current block based on the chroma prediction model of the chroma current block.

In an implementation of the first aspect of the present disclosure, the luma corresponding block is one of the luma current block and a luma neighboring block neighboring the luma current block.

In an implementation of the first aspect of the present disclosure, the luma block vector of the luma corresponding block is determined using one of an intra block copy (IBC) mode and an intra template matching prediction (intraTMP) mode to indicate the luma reference block for reconstructing the luma corresponding block.

An implementation of the first aspect of the present disclosure further includes determining a chroma reference region based on the chroma reference block; determining a luma reference region based on the luma reference block; and deriving the chroma prediction model of the chroma current block based on the chroma reference region and the luma reference region, wherein the chroma current block is reconstructed based on the luma corresponding block and the chroma prediction model of the chroma current block.

In an implementation of the first aspect of the present disclosure, the chroma prediction model of the chroma current block is determined using one of multiple intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode.

In an implementation of the first aspect of the present disclosure, the chroma prediction model of the chroma current block is identical to a chroma reference model of the chroma reference block when chroma reference block is reconstructed based on the chroma reference model, and the chroma reference model of the chroma current block is determined using one of multiple intra prediction model modes including a CCLM mode, a MMLM mode, a CCCM mode, a GLM mode, and a slope adjustment of a linear model mode.

An implementation of the first aspect of the present disclosure further includes determining a chroma reference region based on the chroma reference block; determining a chroma current region based on the chroma current block; and deriving the chroma prediction model of the chroma current block based on the chroma reference region and the chroma current region, wherein the chroma current block is reconstructed based on the chroma reference block and the chroma prediction model of the chroma current block.

An implementation of the first aspect of the present disclosure further includes predicting the chroma current block based on the chroma prediction model of the chroma current block to generate a first chroma predicted block determined based on the luma block vector; predicting the chroma current block based on one of multiple intra prediction modes other than multiple intra prediction model modes to generate a second chroma predicted block; weightedly combining the first chroma predicted block and the second chroma predicted block to generate a chroma prediction block of the chroma current block; and reconstructing the chroma current block based on the chroma prediction block of the chroma current block.

In an implementation of the first aspect of the present disclosure, the multiple intra prediction modes other than the plurality of intra prediction model modes includes a direct block vector (DBV) mode, a DC mode, a Planar mode, and a plurality of intra angular modes.

In an implementation of the first aspect of the present disclosure, the chroma prediction model of the chroma current block is further adjusted by at least one of a plurality of adjustment parameters.

An implementation of the first aspect of the present disclosure further includes determining whether a tree type of the chroma current block is a dual tree; when the tree type of the chroma current block is the dual tree, determining, from the video data, a syntax element indicating whether the chroma current block is reconstructed based on the chroma prediction model of the chroma current block derived based on the luma block vector; and when the tree type of the chroma current block is not the dual tree, ignoring to determine the syntax element from the video data.

An implementation of the first aspect of the present disclosure further includes determining whether a slice type of the chroma current block is a I-slice type; when the slice type of the chroma current block is the I-slice type, determining, from the video data, a syntax element indicating whether the chroma current block is reconstructed based on the chroma prediction model of the chroma current block derived based on the luma block vector; and when the slice type of the chroma current block is not the I-slice type, ignoring to determine the syntax element from the video data.

In a second aspect of the present disclosure, a method of decoding video data and an electronic device for performing the method are provided. The electronic device includes one or more processors; and one or more non-transitory computer-readable media coupled to the one or more processors and storing one or more computer-executable instructions that, when executed by at least one of the one or more processors, cause the at least one of the one or more processors to perform the method. The method includes receiving the video data; receiving the video data; determining a chroma current block from a current frame included in the video data; determining, from the current frame, a chroma reference block indicated by a chroma block vector of the chroma current block, wherein the chroma block vector of the chroma current block is determined using an intra template matching prediction (intraTMP) mode to indicate the chroma reference block; deriving a chroma prediction model of the chroma current block based on the chroma reference block; and reconstructing the chroma current block based on the chroma prediction model of the chroma current block.

An implementation of the second aspect of the present disclosure further includes determining, from the current frame, a luma reference block based on the chroma reference block.

In an implementation of the second aspect of the present disclosure, the luma reference block is collocated with the chroma reference block.

An implementation of the second aspect of the present disclosure further includes determining a chroma reference region based on the chroma reference block; determining a luma reference region based on the luma reference block; and deriving the chroma prediction model of the chroma current block based on the chroma reference region and the luma reference region, wherein the chroma current block is reconstructed based on a luma current block and the chroma prediction model of the chroma current block, and the luma current block is collocated with the chroma current block.

In an implementation of the second aspect of the present disclosure, the chroma prediction model of the chroma current block is determined using one of multiple intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode.

In an implementation of the second aspect of the present disclosure, the chroma prediction model of the chroma current block is identical to a chroma reference model of the chroma reference block when chroma reference block is reconstructed based on the chroma reference model, and the chroma reference model of the chroma current block is determined using one of multiple intra prediction model modes including a CCLM mode, a MMLM mode, a CCCM mode, a GLM mode, and a slope adjustment of a linear model mode.

An implementation of the second aspect of the present disclosure further includes determining a chroma reference region based on the chroma reference block; determining a chroma current region based on the chroma current block; and deriving the chroma prediction model of the chroma current block based on the chroma reference region and the chroma current region, wherein the chroma current block is reconstructed based on the chroma reference block and the chroma prediction model of the chroma current block.

An implementation of the second aspect of the present disclosure further includes predicting the chroma current block based on the chroma prediction model of the chroma current block to generate a first chroma predicted block determined based on the chroma block vector; predicting the chroma current block based on one of multiple intra prediction modes other than multiple intra prediction model modes to generate a second chroma predicted block; weightedly combining the first chroma predicted block and the second chroma predicted block to generate a chroma prediction block of the chroma current block; and reconstructing the chroma current block based on the chroma prediction block of the chroma current block.

In an implementation of the second aspect of the present disclosure, the multiple intra prediction modes other than the plurality of intra prediction model modes includes a direct block vector (DBV) mode, a DC mode, a Planar mode, and a plurality of intra angular modes.

In an implementation of the second aspect of the present disclosure, the chroma prediction model of the chroma current block is further adjusted by at least one of a plurality of adjustment parameters.

An implementation of the second aspect of the present disclosure further includes determining whether a tree type of the chroma current block is a dual tree; when the tree type of the chroma current block is the dual tree, determining, from the video data, a syntax element indicating whether the chroma current block is reconstructed based on the chroma prediction model of the chroma current block derived based on the chroma block vector; and when the tree type of the chroma current block is not the dual tree, ignoring to determine the syntax element from the video data.

An implementation of the second aspect of the present disclosure further includes determining whether a slice type of the chroma current block is a I-slice type; when the slice type of the chroma current block is the I-slice type, determining, from the video data, a syntax element indicating whether the chroma current block is reconstructed based on the chroma prediction model of the chroma current block derived based on the chroma block vector; and when the slice type of the chroma current block is not the I-slice type, ignoring to determine the syntax element from the video data.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIGS. 4A-4B are schematic illustrations of multiple candidates of the chroma reference block of a chroma current block and multiple candidates of the luma reference block of a luma corresponding blocks, in accordance with one or more example implementations of this disclosure.

FIG. 5 is a flowchart illustrating a method/process for decoding and/or encoding video data by an electronic device, in accordance with one or more example implementations of this disclosure.

FIG. 6 is a block diagram illustrating an encoder module of the first electronic device illustrated in FIG. 1, in accordance with one or more example implementations of this disclosure.

### DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

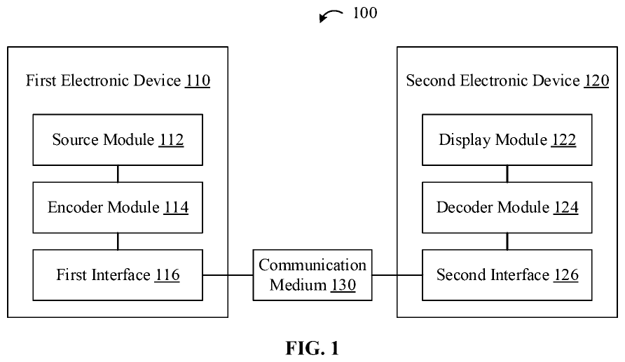

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

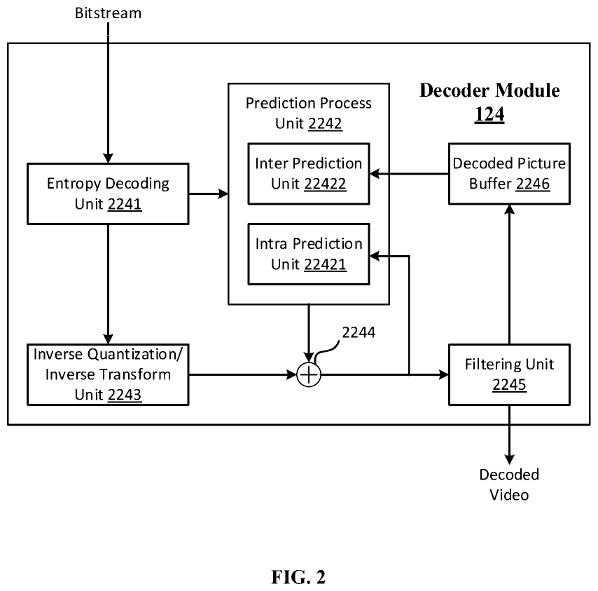

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame.

The intra prediction unit 22421 may reconstruct multiple chroma samples of the current block unit based on multiple luma samples of the current block unit when the luma samples of the current block unit have been reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove blocking artifacts from the reconstructed block. Additional filters (in loop or post loop) may also be used in addition to the deblocking filter, the SAO filter, the bilateral filter, and the ALF. Such filters are not explicitly illustrated for brevity but may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any of a variety of memory devices, such as dynamic random-access memory (DRAM), including synchronous DRAM (SDRAM), magneto-resistive RAM (MRAM), resistive RAM (RRAM), or other types of memory devices. The decoded picture buffer 2246 may be on-chip with other components of the decoder module 124 or off-chip relative to those components.

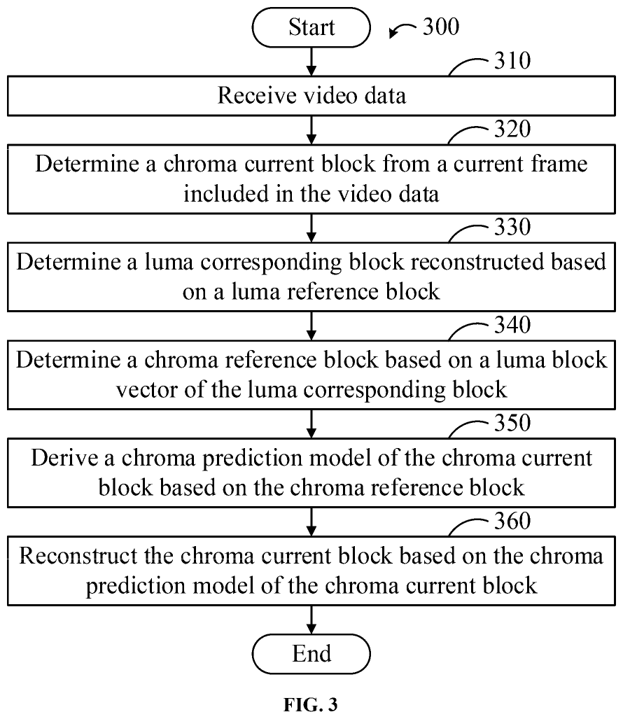

FIG. 3 is a flowchart illustrating a method/process 300 for decoding and/or encoding video data by an electronic device, in accordance with one or more example implementations of this disclosure. The method/process 300 is an example implementation, as there are a variety of ways of decoding the video data.

The method/process 300 may be performed by an electronic device using the configurations illustrated in FIGS. 1 and 2, and various elements of these figures are referenced with the description of the method/process 300. Each block illustrated in FIG. 3 may represent one or more processes, methods, or subroutines performed by an electronic device.

The order in which the blocks appear in FIG. 3 is for illustration only, and may not be intended to limit the scope of the present disclosure, thus may be different from what is illustrated. Additional blocks may be added or fewer blocks may be utilized without departing from the present disclosure.

At block 310, the method/process 300 may start by the decoder module 124 receiving the video data. The video data received by the decoder module 124 may include a bitstream.

With reference to FIGS. 1 and 2, the second electronic device 120 may receive the bitstream from an encoder, such as the first electronic device 110 (or other video providers) via the second interface 126. The second interface 126 may provide the bitstream to the decoder module 124.

At block 320, the decoder module 124 determines a chroma current block from a current frame included in the video data.

With reference to FIGS. 1 and 2, the decoder module 124 may determine multiple image frames included in the bitstream when the video data received by the decoder module 124 is the bitstream. The current frame may be one of the image frames determined according to the bitstream. The decoder module 124 may further divide the current frame to determine a block unit according to multiple partition indications in the bitstream. For example, the decoder module 124 may divide the current frame to generate a plurality of CTUs, and further divide one of the CTUs to determine the block unit including the chroma current block and a luma current block according to the partition indications based on any video coding standard.

The one of the CTUs for determining the block unit may include a luma coding tree block (CTB) and at least one chroma CTB. In some implementations, the at least one chroma CTB may be two chroma CTBs (e.g., a Cr CTB and a Cb CTB). The luma CTB may be divided into one or more luma coding units, and each of the at least one chroma CTB may be divided into one or more chroma coding units. A luma partitioning structure of the one or more luma coding units in the luma CTB may be identical to or different from a chroma partitioning structure of the one or more chroma coding units in each of the at least one chroma CTB. When a tree type of the one of the CTUs is a single tree, the luma partitioning structure of the one or more luma coding units in the luma CTB may be identical to the chroma partitioning structure of the one or more chroma coding units in each of the at least one chroma CTB. When the tree type of the one of the CTUs is a dual tree, the luma partitioning structure of the one or more luma coding units in the luma CTB may be different from the chroma partitioning structure of the one or more chroma coding units in each of the at least one chroma CTB. A specific one of the one or more chroma coding units in one of the at least one chroma CTB may be regarded as the chroma current block.

In some implementations, the tree type of the chroma current block may be the single tree. When a specific one of the one or more luma coding units in the luma CTU is collocated with the chroma current block, the specific one of the one or more luma coding units in the luma CTU may be regarded as the luma current block. In some implementations, when a luma location of a top-left sample in the specific one of the one or more luma coding units in the luma CTU is collocated with a chroma location of a top-left sample in the specific one of the one or more chroma coding units in one of the at least one chroma CTB, the specific one of the one or more luma coding units in the luma CTU is the luma current block collocated with the chroma current block. In some other implementations, when one of multiple luma locations in the specific one of the one or more luma coding units in the luma CTU is collocated with the chroma location of the top-left sample in the specific one of the one or more chroma coding units in one of the at least one chroma CTB, the specific one of the one or more luma coding units in the luma CTU is the luma current block collocated with the chroma current block.

In some implementations, the tree type of the chroma current block may be the dual tree. The luma partitioning structure may be different from the chroma partitioning structure so there may be no luma coding unit which is directly collocated with the chroma current block. The decoder module 124 may determine the chroma location of the top-left sample in the chroma current block, and determine a collocated location collocated with the chroma location of the top-left sample. Then, the decoder module 124 may determine the luma current block based on the collocated location, a chroma current size of the chroma current block, and multiple scaling factors. The decoder module 124 may derive a luma current size based on the chroma current size and the scaling factors, and then determine the luma current block based on the collocated location and the luma current size.

At block 330, the decoder module 124 determines a luma corresponding block reconstructed based on a luma reference block.

With reference to FIGS. 1 and 2, the decoder module 124 may determine the luma current block collocated with the chroma current block, and then determine the luma corresponding block based on the luma current block collocated with the chroma current block. The luma corresponding block may be one of the luma current block and multiple luma neighboring blocks neighboring the luma current block. In some implementations, the decoder module 124 may directly determine the luma current block as the luma corresponding block. In some other implementations, the decoder module 124 may determine a specific one of the luma neighboring blocks neighboring the luma current block, and then determine the specific luma neighboring block as the luma corresponding block.

In some implementations, the specific luma neighboring block may be located above the luma current block. For example, a top-left sample in the luma current block may be located at a luma current location (xCb, yCb), and a block size of the luma current block may be the luma current size (cbWidth, cbHeigh). The specific luma neighboring block located above the luma current block may include a first luma sample located at a first luma neighboring location (xCb+cbWidth−1, yCb−1). In some other implementations, the specific luma neighboring block may be located at a left side of the luma current block. For example, the specific luma neighboring block located at the left side of the luma current block may include a second luma sample located at a second luma neighboring location (xCb−1, yCb+cbHeight−1).

The luma current block may be reconstructed prior to reconstructing the chroma current block. In addition, the luma neighboring blocks neighboring the luma current block may be reconstructed prior to reconstructing the luma current block. Thus, the luma corresponding block may be reconstructed prior to reconstructing the chroma current block since the luma corresponding block may be one of the luma current block and the luma neighboring blocks. Furthermore, since the luma corresponding block is reconstructed based on the luma reference block, the luma reference block may be reconstructed prior to reconstructing the luma corresponding block. Thus, the luma reference block may also be reconstructed prior to reconstructing the chroma current block. The luma corresponding block and the luma reference block may be included in the current frame.

At block 340, the decoder module 124 determines a chroma reference block based on a luma block vector of the luma corresponding block.

With reference to FIGS. 1 and 2, the decoder module 124 may determine the luma block vector of the luma corresponding block for determining the luma reference block. Then, the decoder module 124 may determine the chroma block vector of the chroma current block based on the luma block vector for determining the chroma reference block. Thus, both of the chroma reference block and the luma reference block may be determined based on the luma block vector of the luma corresponding block. Both of the chroma reference block and the luma reference block may be associated with the luma block vector of the luma corresponding block. The luma block vector of the luma corresponding block may direct from the luma corresponding block towards the luma reference block.

When the chroma reference block and the luma reference block are associated with the luma block vector of the luma corresponding block, the luma block vector of the luma corresponding block indicating that the luma reference block is a reference block unit for reconstructing the luma corresponding block may be used to derive the chroma block vector. In some implementations, the decoder module 124 may determine whether the luma current block and the luma neighboring blocks are decoded using one of an intra block copy (IBC) mode and an intra template matching prediction (intraTMP) mode. When the luma current block is decoded using one of the IBC mode and the intraTMP mode, a luma current vector of the luma current block generated by the one of the IBC mode and the intraTMP mode may be determined as the luma block vector of the luma corresponding block. When the specific luma neighboring block is decoded using one of the IBC mode and the intraTMP mode, a luma neighboring vector of the specific luma neighboring block generated by the one of the IBC mode and the intraTMP mode may determined as the luma block vector of the luma corresponding block. In some implementations, the luma block vector of the luma corresponding block may be determined using one of the IBC mode and the intraTMP mode to indicate the luma reference block for reconstructing the luma corresponding block. When the luma block vector of the luma corresponding block is determined using the IBC mode, the decoder module 124 may determine the luma block vector of the luma corresponding block based on the bitstream. When the luma block vector is determined using the intraTMP mode, the decoder module 124 may select the luma reference block from multiple intraTMP corresponding blocks of the luma corresponding block and determine the luma block vector associated with the luma reference block.

In some implementations, the luma corresponding block may not be a coding unit directly selected from the one or more luma coding units in the luma CTU. In some implementations, the luma corresponding block may be a portion of a specific one of the one or more luma coding units in the luma CTU. In other words, the luma corresponding block may be included in the specific luma coding unit. Thus, when the specific luma coding unit is decoded using one of the IBC mode and the intraTMP mode, a luma coding vector of the specific luma coding unit may be determined as the luma block vector of the luma corresponding block. In some other implementations, the luma corresponding block may include more than one of the luma coding units in the luma CTU. The decoder module 124 may determine multiple coding locations of the luma corresponding block, and determine whether the luma coding units each covering at least one of the coding locations and included in the luma corresponding block are decoded using one of the IBC mode and the intraTMP mode. When a specific one of the luma coding units covering at least one of the coding locations and included in the luma corresponding block is decoded using one of the IBC mode and the intraTMP mode, the luma coding vector of the specific luma coding unit may be determined as the luma block vector of the luma corresponding block. In some implementations, the coding locations may include at least one of a top-left corner, a top-right corner, a bottom-left corner, a bottom-right corner, and a central point of the luma corresponding block.

The decoder module 124 may determine the chroma block vector (cbvₓ, cbv_{y}) of the chroma current block based on the luma block vector (lbvₓ, lbv_{y}) of the luma corresponding block. In some implementations, the chroma block vector (cbvₓ, cbv_{y}) may be identical to the luma block vector (lbvₓ, lbv_{y}). In some other implementations, the chroma block vector (cbvₓ, cbv_{y}) may be proportional to the luma block vector (lbvₓ, lbv_{y}).

The chroma block vector may be derived based on the scaling factors and the luma block vector. In some implementations, the scaling factors may include a first scaling factor and a second scaling factor. The first scaling factor may be identical to or different from the second scaling factor. The first scaling factor may be used to proportionally adjust a first length along a first direction, and the second scaling factor may be used to proportionally adjust a second length along a second direction. The first direction may be perpendicular to the second direction. In some implementations, the first scaling factor may be a width scaling factor, and the second scaling factor may be a height scaling factor.

The chroma block vector (cbvₓ, cbv_{y}) of the chroma current block may be derived based on the luma block vector (lbvₓ, lbv_{y}) of the luma corresponding block and the scaling factors. For example, a horizontal component cbvₓ of the chroma block vector may be generated by dividing a horizontal component lbvₓ of the luma block vector by the width scaling factor, and a vertical component cbv_{y} of the chroma block vector may be generated by dividing a vertical component lbv_{y} of the luma block vector by the height scaling factor.

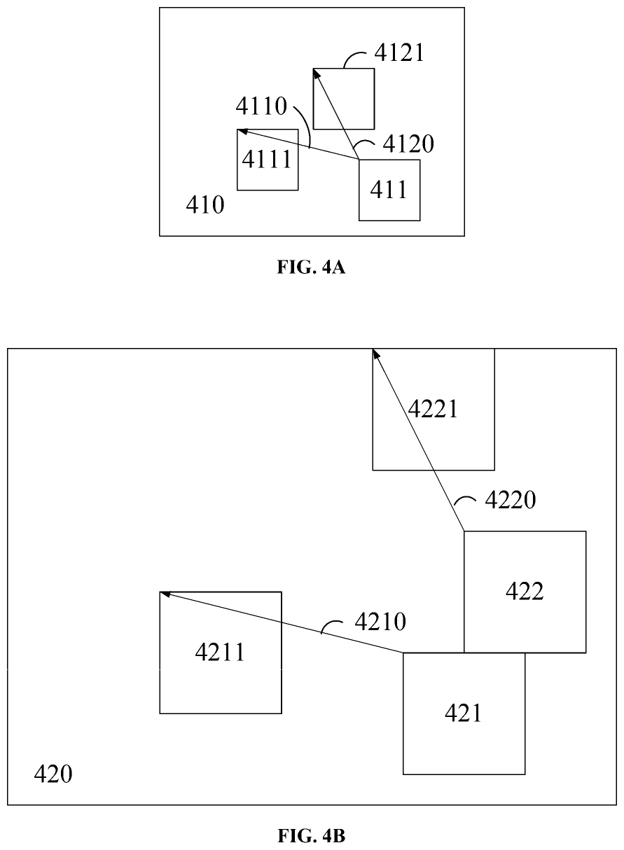

FIGS. 4A-4B are schematic illustrations of multiple candidates of the chroma reference block of a chroma current block and multiple candidates of the luma reference block of a luma corresponding blocks, in accordance with one or more example implementations of this disclosure. The decoder module 124 may determine the chroma current block 411 from a chroma frame 410 and then determine the luma current block 421 collocated with the chroma current block 411 from a luma frame 420. The decoder module 124 may further determine the luma corresponding block based on the luma current block 421 from the luma frame 420.

The decoder module 124 may directly set the luma current block 421 as the luma corresponding block when the luma current block 421 is reconstructed based on a first luma reference candidate 4211 indicated by a first luma vector candidate 4210. In addition, the first luma vector candidate 4210 and the first luma reference candidate 4211 of the luma current block 421 may be set as the luma block vector and the luma reference block of the luma corresponding block.

The decoder module 124 may directly select a specific luma neighboring block 422 from multiple luma neighboring blocks as the luma corresponding block when the specific luma neighboring block 422 is reconstructed based on a second luma reference candidate 4221 indicated by a second luma vector candidate 4220. In addition, the second luma vector candidate 4220 and the second luma reference candidate 4221 of the specific luma neighboring block 422 may be set as the luma block vector and the luma reference block of the luma corresponding block.

The decoder module 124 may determine the chroma block vector based on the luma block vector and determine the chroma reference block from the chroma frame 410 based on the chroma block vector. In some implementations, when the first luma vector candidate 4210 of the luma current block 421 is set as the luma block vector of the luma corresponding block, the decoder module 124 may determine a first chroma vector candidate 4110 as the chroma current vector based on the first luma vector candidate 4210 of the luma current block 421. Then, the decoder module 124 may determine a first chroma reference candidate 4111 as the chroma reference block based on the first chroma vector candidate 4110. In some other implementations, when the second luma vector candidate 4220 of the specific luma neighboring block 422 is set as the luma block vector of the luma corresponding block, the decoder module 124 may determine a second chroma vector candidate 4120 as the chroma current vector based on the second luma vector candidate 4220 of the specific luma neighboring block 422. Then, the decoder module 124 may determine a second chroma reference candidate 4121 as the chroma reference block based on the second chroma vector candidate 4120.

The chroma current size of the chroma current block may be proportional to a luma corresponding size of the luma corresponding block and a luma reference size of the luma reference block based on the scaling factors. For example, a luma corresponding width W_{LC} of the luma corresponding block and a luma reference width W_{LR} of the luma reference block may be equal to a luma width value generated by multiplying a chroma current width W_{CC} of the chroma current block by the width scaling factor. A luma corresponding height H_{LC} of the luma corresponding block and a luma reference height H_{LR} of the luma reference block may be equal to a luma height value generated by multiplying a chroma current height H_{CC} of the chroma current block by the height scaling factor. In addition, a chroma reference width W_{CR} of the chroma reference block may be equal to the chroma current width W_{CC} of the chroma current block, and a chroma reference height H_{CR} of the chroma reference block may be equal to the chroma current height H_{CC} of the chroma current block.

The scaling factors may be derived based on a video format. For example, when the video format is YUV444, the first scaling factor may be the width scaling factor equal to one, and the second scaling factor may be the height scaling factor equal to one. In addition, when the video format is YUV422, the first scaling factor may be the width scaling factor equal to two, and the second scaling factor may be the height scaling factor equal to one. When the video format is YUV420, the first scaling factor may be the width scaling factor equal to two, and the second scaling factor may be the height scaling factor equal to two.

Referring back to FIG. 3, at block 350, the decoder module 124 derives a chroma prediction model of the chroma current block based on the chroma reference block.

With reference to FIGS. 1 and 2, in some implementations, the decoder module 124 may determine a chroma reference region based on the chroma reference block, and determine a luma reference region based on the luma reference block. Then, the decoder module 124 may derive the chroma prediction model of the chroma current block based on the chroma reference region and the luma reference region. In some other implementations, the decoder module 124 may determine the chroma reference region based on the chroma reference block, and determine a chroma current region based on the chroma current block. Then, the decoder module 124 may derive the chroma prediction model of the chroma current block based on the chroma reference region and the chroma current region.

The decoder module 124 may determine multiple chroma reference areas neighboring the chroma reference block, and determine multiple luma reference areas neighboring the luma reference block. In some implementations, the chroma reference region may only include the chroma reference block, and the luma reference region may only include the luma reference block. In some other implementations, the chroma reference region may only include at least one of the chroma reference areas, and the luma reference region may only include at least one of the luma reference areas. In yet other implementations, the chroma reference region may include the chroma reference block and at least one of the chroma reference areas, and the luma reference region may include the luma reference block and at least one of the luma reference areas.

The chroma reference areas may include a first chroma reference area located to a left side of the chroma reference block, a second chroma reference area located above the chroma reference block, and a third chroma reference area located to a top-left side of the chroma reference block. The chroma reference areas may be reconstructed prior to the reconstruction of the chroma current block. The luma reference areas may include a first luma reference area located to a left side of the luma reference block, a second luma reference area located above the luma reference block, and a third luma reference area located to a top-left side of the luma reference block. The luma reference areas may be reconstructed prior to the reconstruction of the chroma current block.

The decoder module 124 may determine the chroma reference areas neighboring the chroma reference block, and determine multiple chroma current areas neighboring the chroma current block. The chroma reference region may only include at least one of the chroma reference areas, and the chroma current region may only include at least one of the chroma current areas.

The chroma reference areas may include the first chroma reference area, the second chroma reference area, and the third chroma reference area. The chroma current areas may include a first chroma current area located to a left side of the chroma current block, a second chroma current area located above the chroma current block, and a third chroma current area located to a top-left side of the chroma current block. The chroma current areas may be reconstructed prior to the reconstruction of the chroma current block.

The usage of the chroma reference areas and the chroma reference block in the chroma reference region may correspond to the usage of the luma reference areas and the luma reference block in the luma reference region. The usage of the chroma reference areas and the chroma reference block in the chroma reference region and the usage of the luma reference areas and the luma reference block in the luma reference region may include multiple reference direction types. In addition, the usage of the chroma reference areas in the chroma reference region may correspond to the usage of the chroma current areas in the chroma current region. The usage of the chroma reference areas in the chroma reference region and the usage of the chroma current areas in the chroma current region may include the reference direction types. In some implementations, the usage of the chroma reference areas and the chroma reference block in the chroma reference region may include three reference direction types, i.e., a left type (L type), a top type (T type), and a left-top type (LT type).

In some implementations, the chroma reference region in the L type may only include the first chroma reference area located to the left side of the chroma reference block, and the luma reference region in the L type may only include the first luma reference area located to the left side of the luma reference block. In some other implementations, the chroma reference region in the L type may include the chroma reference block and the first chroma reference area, and the luma reference region in the L type may include the luma reference block and the first luma reference area. In addition, the chroma reference region in the L type may only include the first chroma reference area, and the chroma current region in the L type may only include the first chroma current area located to the left side of the chroma current block.

In some implementations, the chroma reference region in the T type may only include the second chroma reference area located above the chroma reference block, and the luma reference region in the T type may only include the second luma reference area located above the luma reference block. In some other implementations, the chroma reference region in the T type may include the chroma reference block and the second chroma reference area, and the luma reference region in the T type may include the luma reference block and the second luma reference area. In addition, the chroma reference region in the T type may only include the second chroma reference area, and the chroma current region in the T type may only include the second chroma current area located above the chroma current block.

In some implementations, the chroma reference region in the LT type may only include the first chroma reference area and the second chroma reference area, and the luma reference region in the LT type may only include the first luma reference area and the second luma reference area. In some other implementations, the chroma reference region in the LT type may include the chroma reference block, the first chroma reference area, and the second chroma reference area, and the luma reference region in the LT type may include the luma reference block, the first luma reference area, and the second luma reference area. In some other implementations, the chroma reference region in the LT type may include the first chroma reference area, the second chroma reference area, and the third chroma reference area located to the top-left side of the chroma reference block, and the luma reference region in the LT type may include the first luma reference area, the second luma reference area, and the third luma reference area located to the top-left side of the luma reference block. In some other implementations, the chroma reference region in the LT type may include the chroma reference block, the first chroma reference area, the second chroma reference area, and the third chroma reference area, and the luma reference region in the LT type may include the luma reference block, the first luma reference area, the second luma reference area, the third luma reference area. In yet some implementations, the chroma reference region in the LT type may only include the chroma reference block, and the luma reference region in the LT type may only include the luma reference block.

In some implementations, the chroma reference region in the LT type may only include the first chroma reference area and the second chroma reference area, and the chroma current region in the LT type may only include the first chroma current area and the second chroma current area. In some other implementations, the chroma reference region in the LT type may include the first chroma reference area, the second chroma reference area, and the third chroma reference area located to the top-left side of the chroma reference block, and the chroma current region in the LT type may include the first chroma current area, the second chroma current area, and the third chroma current area located to the top-left side of the chroma current block.

In some implementations, the chroma prediction model of the chroma current block may be determined using one of a plurality of intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode, when the decoder module 124 derives the chroma prediction model of the chroma current block based on the chroma reference region and the luma reference region. Then, the decoder module 124 may reconstruct the chroma current block based on the luma corresponding block and the chroma prediction model of the chroma current block.

In the CCLM mode, the decoder module 124 may directly derive multiple prediction model parameters of a chroma linear model for the chroma current block based on multiple sample correlations between multiple chroma reference samples in the chroma reference region and multiple luma reference samples in the luma reference region. Then, the decoder module 124 may set the chroma linear model as the chroma prediction model of the chroma current block for reconstructing the chroma current block.

In the MMLM mode, the decoder module 124 may divide the sample correlations between the chroma reference samples in the chroma reference region and the luma reference samples in the luma reference region into multiple sample groups. The decoder module 124 may derive multiple prediction model parameters of a chroma linear model for each of the sample groups based on the sample correlations in the corresponding sample group. Thus, in the MMLM mode, the sample groups may correspond one-by-one to the chroma linear models, and the number of the sample groups may be equal to the number of the chroma linear models. Then, the decoder module 124 may set a combination of the chroma linear models as the chroma prediction model of the chroma current block for reconstructing the chroma current block.

In the CCCM mode, the decoder module 124 may directly derive multiple prediction model parameters of a chroma convolution filter for the chroma current block based on multiple sample correlations between multiple chroma reference samples in the chroma reference region and multiple luma reference samples in the luma reference region. In some implementations, the chroma convolution filter may be a M-tap filter. In some implementations, the number M may be equal to a positive integer. For example, the number M may be equal to 7. Then, the decoder module 124 may set the chroma convolution filter as the chroma prediction model of the chroma current block for reconstructing the chroma current block. The prediction model parameters of the chroma prediction model may be derived by minimizing the difference between the chroma reference region and luma reference region. In some implementations, the difference minimization may be performed by a mean square error (MSE) minimization. In some implementations, the MSE minimization may be performed by calculating autocorrelation matrix. The autocorrelation matrix may be LDL-decomposed and the prediction model parameters may be calculated using back-substitution. In some implementations, the decomposition may be Cholesky decomposition.

In some implementations, when the prediction model parameters are derived based on the chroma reference region and the luma reference region, the chroma prediction model of the chroma current block may be determined based on the prediction model parameters, as follows:

$${Pred}_{CC} ( i , j ) = {c}_{0} \times {Ref}_{LC} ( i , j ) + {c}_{1} {Ref}_{LC} ( i , j - 1 ) + {c}_{2} \times {Ref}_{LC} ( i , j + 1 ) + {c}_{3} \times {Ref}_{LC} ( i - 1 , j ) + {c}_{4} \times {Ref}_{LC} ( i + 1 , j ) + {c}_{5} \times P + {c}_{6} \times B$$

$$P = [ {Ref}_{LC} ( i , j ) \times {Ref}_{LC} ( i , j ) + midVal ] ≫ bitDepth$$

$$B = {2}^{bitDepth - 1}$$

In the above equation, c₀-c_{S} may be the first to the sixth coefficients of the chroma prediction model of the chroma current block, Pred_{CC}(i,j) may be multiple predicted samples in the chroma current block, Ref_{LC}(i,j) may be multiple reconstructed samples in the luma corresponding block, midVal may be a mid-value of sample values, and the bias term B may be represented as a scalar offset between luma values and chroma values. In some implementations, the first to the sixth coefficients of the chroma prediction model may be equal to the prediction model parameters determined based on the sample correlations between the chroma reference samples in the chroma reference region and the luma reference samples in the luma reference region. In some implementations, midVal may be equal to 512 when a bitdepth of the chroma current block is equal to 10. In some implementations, the bias term B may be set as a middle chroma value. For example, the bias term B may be equal to 512 when the bitdepth of the chroma current block is equal to 10. In some implementations, the decoder module 124 may apply the reconstructed samples Ref_{LC}(i,j) to the chroma prediction model to generate the predicted samples Pred_{CC}(i,j) in the chroma current block.

In the GLM mode, the decoder module 124 may determine multiple luma gradient values based on the luma reference samples in the luma reference region. In some implementations, the gradient filter may be a Sobel filter. The decoder module 124 may derive multiple prediction model parameters of a chroma linear model for the chroma current block based on multiple gradient correlations between the chroma reference samples in the chroma reference region and the luma gradient values in the luma reference region. Then, the decoder module 124 may set the chroma linear model as the chroma prediction model of the chroma current block for reconstructing the chroma current block.

In the slope adjustment of the linear model mode, the decoder module 124 may further adjust at least one chroma linear model of the chroma prediction model based on multiple adjustment parameters. For example, the chroma linear model in the CCLM mode and the GLM mode may be adjusted. In addition, the chroma linear models in the MMLM may be adjusted. The adjustment parameters may include multiple slope adjustment parameters and multiple constant adjustment parameters. When a chroma linear model including a slope linear parameter and a constant linear parameter is adjusted, zero or one of the slope adjustment parameters may adjust the slope linear parameter and zero or one of the constant adjustment parameters may adjust the constant linear parameter. Thus, in the slope adjustment of the linear model mode, the chroma prediction model of the chroma current block may be adjusted by at least one of the adjustment parameters.

In some implementations, a prediction model filter may be determined as the chroma prediction model of the chroma current block, when the decoder module 124 derives the prediction model parameters of the chroma prediction model of the chroma current block based on the chroma reference region and the chroma current region. Then, the decoder module 124 may reconstruct the chroma current block based on the chroma reference block and the chroma prediction model of the chroma current block. In some implementations, the prediction model filter may be a M-tap filter. The prediction model parameters of the chroma prediction model may be derived by minimizing the difference between a prediction of the chroma reference region and chroma current region. In some implementations, the difference minimization may be performed by the MSE minimization. In some implementations, the MSE minimization may be performed by calculating autocorrelation matrix. The autocorrelation matrix may be LDL-decomposed and the filter coefficients may be calculated using back-substitution. In some implementations, the decomposition may be Cholesky decomposition.

In some implementations, when the prediction model parameters are derived based on the chroma reference region and the chroma current region, the chroma prediction model of the chroma current block may be determined based on the prediction model parameters, as follows:

$${Pred}_{CC} ( i , j ) = {w}_{0} \times {Ref}_{CR} ( i - 1 , j ) + {w}_{1} \times {Ref}_{CR} ( i , j ) + {w}_{2} \times {Ref}_{CR} ( i + 1 , j ) + {w}_{3} \times {Ref}_{CR} ( i - 1 , j + 1 ) + {w}_{4} \times {Ref}_{CR} ( i , j + 1 ) + {w}_{5} \times {Ref}_{CR} ( i + 1 , j + 1 )$$

In the above equation, w₀-w_{S} may be the first to the sixth coefficients of the prediction model filter of the chroma current block, Pred_{CC}(i,j) may be multiple predicted samples in the chroma current block, and Ref_{CR}(i,j) may be multiple reconstructed samples in the chroma reference block. In some implementations, the first to the sixth coefficients of the chroma prediction model may be equal to the prediction model parameters determined based on the sample correlations between the chroma reference samples in the chroma reference region and multiple chroma current samples in the chroma current region. In some implementations, the decoder module 124 may apply the reconstructed samples Ref_{CR}(i,j) to the prediction model filter to generate the predicted samples Pred_{CC}(i,j) in the chroma current block.

In some other implementations, when the chroma reference block is reconstructed based on a chroma reference model, the prediction model parameters of the chroma prediction model may be directly inherited from multiple reference model parameters of the chroma reference model. Thus, the chroma prediction model of the chroma current block may be identical to the chroma reference model of the chroma reference block when the chroma reference block is reconstructed based on the chroma reference model. In some implementations, the chroma reference model of the chroma current block may be determined using one of the intra prediction model modes including the CCLM mode, the MMLM mode, the CCCM mode, the GLM mode, and the slope adjustment of the linear model mode.

Referring back to FIG. 3, at block 360, the decoder module 124 reconstructs the chroma current block based on the chroma prediction model of the chroma current block.

With reference to FIGS. 1 and 2, the decoder module 124 may predict the chroma current block based on the chroma prediction model of the chroma current block to generate a first chroma predicted block determined based on the luma block vector. In some implementations, the decoder module 124 may predict the chroma current block based on the luma corresponding block based on the luma block vector and the chroma prediction model of the chroma current block to generate a first chroma predicted block when the chroma prediction model of the chroma current block is derived based on the chroma reference region and the luma reference region. In some other implementations, the decoder module 124 may predict the chroma current block based on the chroma reference block determined based on the luma block vector and the chroma prediction model of the chroma current block to generate the first chroma predicted block when the chroma prediction model of the chroma current block is derived based on the chroma reference region and the chroma current region. In some other implementations, multiple input samples of the chroma prediction model may be determined based on multiple input samples of the chroma reference model determined based on the luma block vector when the chroma prediction model of the chroma current block is directly inherited from the chroma reference model of the chroma reference block. For example, the input samples of the chroma prediction model may be determined from multiple luma reconstructed samples in the luma corresponding block when the input samples of the chroma reference model are determined from multiple luma reconstructed samples in the current frame. In addition, the input samples of the chroma prediction model may be determined from multiple chroma reconstructed samples in the chroma reference block when the input samples of the chroma reference model are determined from multiple chroma reconstructed samples in the current frame.

The decoder module 124 may predict the chroma current block based on at least one of multiple intra prediction modes other than the intra prediction model modes to generate at least one second chroma predicted block. In some implementations, the intra prediction modes other than the intra prediction model modes includes a direct block vector (DBV) mode, a DC mode, a Planar mode, and multiple intra angular modes. In some implementations, when one of the intra prediction modes other than the intra prediction model modes is one of the intra angular modes, the one of the intra prediction modes other than the intra prediction model modes may be determined using a normal intra direction mode (i.e., signaling by an intra prediction index), a decoder side intra-prediction mode determination (DIMD), or any other angular determination modes. In some implementations, when one of at least one second chroma predicted block is generated using one of the DC mode, the Planar mode, and the intra angular modes, the one of the DC mode, the Planar mode, and the intra angular modes may be predefined in the method/process 300 without any other selection and/or determination process.

In some implementations, the decoder module 124 may directly set the first chroma predicted block as a chroma prediction block of the chroma current block. In some other implementations, the decoder module 124 may predict the chroma current block based on the first chroma predicted block, the at least one second chroma predicted block and multiple weighting parameters. The decoder module 124 may weightedly combine the first chroma predicted block and the at least one second chroma predicted block based on the weighting parameters to generate the chroma prediction block of the chroma current block. In some implementations, the weighting parameters may be predefined in the decoder module 124. In some other implementations, the weighting parameters may be derived based on multiple intra template matching costs of the first chroma predicted block and the at least one second chroma predicted block. When the number of the at least one second chroma predicted block is equal to one, the decoder module 124 may weightedly combine the first chroma predicted block and the second chroma predicted block based on the weighting parameters to generate the chroma prediction block of the chroma current block.

The decoder module 124 may reconstruct the chroma current block based on the chroma prediction block of the chroma current block. The decoder module 124 may determine multiple chroma residual components from the bitstream for the chroma current block and add the chroma residual components into the chroma prediction block to reconstruct the chroma current block. The decoder module 124 may reconstruct all of the other chroma coding units in the image frame for reconstructing the image frame and the video. The method/process 300 may then end.

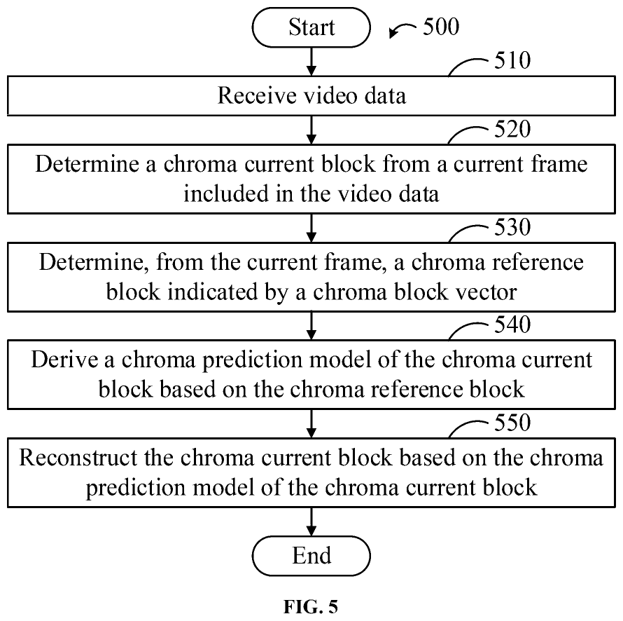

FIG. 5 is a flowchart illustrating a method/process 500 for decoding and/or encoding video data by an electronic device, in accordance with one or more example implementations of this disclosure. The method/process 500 is an example implementation, as there are a variety of ways of decoding the video data.

The method/process 500 may be performed by an electronic device using the configurations illustrated in FIGS. 1 and 2, and various elements of these figures are referenced with the description of the method/process 500. Each block illustrated in FIG. 5 may represent one or more processes, methods, or subroutines performed by an electronic device.

The order in which the blocks appear in FIG. 5 is for illustration only, and may not be intended to limit the scope of the present disclosure, thus may be different from what is illustrated. Additional blocks may be added or fewer blocks may be utilized without departing from the present disclosure.

At block 510, the method/process 500 may start by the decoder module 124 receiving the video data. The video data received by the decoder module 124 may include a bitstream.

With reference to FIGS. 1 and 2, the second electronic device 120 may receive the bitstream from an encoder, such as the first electronic device 110 (or other video providers) via the second interface 126. The second interface 126 may provide the bitstream to the decoder module 124.

At block 520, the decoder module 124 determines a chroma current block from a current frame included in the video data.

With reference to FIGS. 1 and 2, the decoder module 124 may determine multiple image frames included in the bitstream when the video data received by the decoder module 124 is the bitstream. The determination of the chroma current block from the current frame included in the video data at block 520 may be identical to the determination of the chroma current block from the current frame included in the video data at block 320.

At block 530, the decoder module 124 determines, from the current frame, a chroma reference block indicated by a chroma block vector of the chroma current block.

With reference to FIGS. 1 and 2, the decoder module 124 may determine the chroma block vector of the chroma current block for determining the chroma reference block. The chroma block vector of the chroma current block may indicate that the chroma reference block is a model reference information for creating a prediction model to reconstruct the chroma block. In some implementations, the chroma block vector of the chroma current block may be determined using an intra template matching prediction (intraTMP) mode to indicate the chroma reference block without parsing a vector syntax. The decoder module 124 may select the chroma reference block from multiple intraTMP current candidates of the chroma current block and determine the chroma block vector associated with the chroma reference block.

In some implementations, the decoder module 124 may further determine a luma reference block from the current frame based on the chroma reference block. The luma reference block may correspond to the chroma reference block. In some implementations, the luma reference block may be collocated with the chroma reference block. For example, a luma location of a top-left sample in the luma reference block may be collocated with a chroma location of a top-left sample in the chroma reference block. Both of the chroma reference block and the luma reference block may be associated with the chroma block vector of the chroma current block. In some other implementations, the decoder module 124 may determine the chroma reference block from the current frame, and then reconstruct the chroma current block without considering the luma reference block.

With reference to FIGS. 4A and 4B, the decoder module 124 may determine the chroma current block 411, and then determine, from a chroma frame 410, the chroma reference block based on the chroma current block 411. The decoder module 124 may select the chroma reference block from multiple chroma reference candidates based on the chroma current block 411, and determine the chroma current vector directing from the chroma current block towards the chroma reference block.

For example, the decoder module 124 may set the first chroma vector candidate 4110 and the first chroma reference candidate 4111 as the chroma current vector and the chroma reference block of the chroma current block 411. Then, the decoder module 124 may determine the first luma reference candidate 4211 collocated with the first chroma reference candidate 4111 as the luma reference block. In addition, the decoder module 124 may also determine the luma current block 421 collocated with the chroma current block 411. The luma current block 421, and the first luma reference candidate 4211 may be included in the luma frame 420.

A chroma current size of the chroma current block may be proportional to a luma reference size of the luma reference block based on multiple scaling factors. In some implementations, the scaling factors may include a first scaling factor and a second scaling factor. The first scaling factor may be identical to or different from the second scaling factor. The first scaling factor may be used to proportionally adjust a first length along a first direction, and the second scaling factor may be used to proportionally adjust a second length along a second direction. The first direction may be perpendicular to the second direction. In some implementations, the first scaling factor may be a width scaling factor, and the second scaling factor may be a height scaling factor. For example, a luma current width W_{LC} of the luma current block and a luma reference width W_{LR} of the luma reference block may be equal to a luma width value generated by multiplying a chroma current width W_{CC} of the chroma current block by the width scaling factor. A luma current height H_{LC} of the luma current block and a luma reference height HLR of the luma reference block may be equal to a luma height value generated by multiplying a chroma current height H_{CC} of the chroma current block by the height scaling factor. In addition, a chroma reference width W_{CR} of the chroma reference block may be equal to the chroma current width W_{CC} of the chroma current block, and a chroma reference height H_{CR} of the chroma reference block may be equal to the chroma current height H_{CC} of the chroma current block.

The scaling factors may be derived based on a video format. For example, when the video format is YUV444, the first scaling factor may be the width scaling factor equal to one, and the second scaling factor may be the height scaling factor equal to one. In addition, when the video format is YUV422, the first scaling factor may be the width scaling factor equal to two, and the second scaling factor may be the height scaling factor equal to one. When the video format is YUV420, the first scaling factor may be the width scaling factor equal to two, and the second scaling factor may be the height scaling factor equal to two.

At block 540, the decoder module 124 derives a chroma prediction model of the chroma current block based on the chroma reference block.

With reference to FIGS. 1 and 2, in some implementations, the decoder module 124 may determine a chroma reference region based on the chroma reference block, and determine a luma reference region based on the luma reference block. Then, the decoder module 124 may derive the chroma prediction model of the chroma current block based on the chroma reference region and the luma reference region. In some other implementations, the decoder module 124 may determine the chroma reference region based on the chroma reference block, and determine a chroma current region based on the chroma current block. Then, the decoder module 124 may derive the chroma prediction model of the chroma current block based on the chroma reference region and the chroma current region.

In some implementations, the determination of the chroma reference region and the luma reference region at block 540 may be identical to the determination of the chroma reference region and the luma reference region at block 350 when the decoder module 124 derives the chroma prediction model of the chroma current block based on the chroma reference region and the luma reference region. In some other implementations, the determination of the chroma reference region and the chroma current region at block 540 may be identical to the determination of the chroma reference region and the chroma current region at block 350 when the decoder module 124 derives the chroma prediction model of the chroma current block based on the chroma reference region and the chroma current region. The usage of the chroma reference region, the luma reference region, and the chroma current region may also include three reference direction types, i.e., a left type (L type), a top type (T type), and a left-top type (LT type), which is identical to the three reference direction types at block 350.

The chroma prediction model of the chroma current block may be determined using one of a plurality of intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode, when the decoder module 124 derives the chroma prediction model of the chroma current block based on the chroma reference region and the luma reference region. Then, the decoder module 124 may reconstruct the chroma current block based on the luma current block and the chroma prediction model of the chroma current block.

The chroma prediction model of the chroma current block may be determined using a prediction model filter, when the decoder module 124 derives the chroma prediction model of the chroma current block based on the chroma reference region and the chroma current region. Then, the decoder module 124 may reconstruct the chroma current block based on the chroma reference block and the chroma prediction model of the chroma current block. In some implementations, the prediction model filter may be a M-tap filter. Multiple filter coefficients of the prediction model filter may be derived by minimizing the difference between a prediction of the chroma reference region and chroma current region. In some implementations, the difference minimization may be performed by a mean square error (MSE) minimization. In some implementations, the MSE minimization may be performed by calculating autocorrelation matrix. The autocorrelation matrix may be LDL-decomposed and the filter coefficients may be calculated using back-substitution. In some implementations, the decomposition may be Cholesky decomposition.

In some implementations, the prediction model filter may be determined, as follows:

$${Pred}_{CC} ( i , j ) = {w}_{0} \times {Ref}_{CR} ( i - 1 , j ) + {w}_{1} \times {Ref}_{CR} ( i , j ) + {w}_{2} \times {Ref}_{CR} ( i + 1 , j ) + {w}_{3} \times {Ref}_{CR} ( i - 1 , j + 1 ) + {w}_{4} \times {Ref}_{CR} ( i , j + 1 ) + {w}_{5} \times {Ref}_{CR} ( i + 1 , j + 1 )$$

In the above equation, w₀-w_{S} may be the first to the sixth coefficients of the prediction model filter of the chroma current block, Pred_{CC}(i,j) may be multiple predicted samples in the chroma current block, and Ref_{CR}(i,j) may be multiple reconstructed samples in the chroma reference block.

In some other implementations, when the chroma reference block is reconstructed based on a chroma reference model, the prediction model parameters of the chroma prediction model may be directly inherited from multiple reference model parameters of the chroma reference model. Thus, the chroma prediction model of the chroma current block may be identical to the chroma reference model of the chroma reference block when the chroma reference block is reconstructed based on the chroma reference model. In some implementations, the chroma reference model of the chroma current block may be determined using one of the intra prediction model modes including the CCLM mode, the MMLM mode, the CCCM mode, the GLM mode, and the slope adjustment of the linear model mode.

The derivation of the chroma prediction model of the chroma current block at block 540 may be identical to the derivation of the chroma prediction model of the chroma current block at block 350.

Referring back to FIG. 5, at block 550, the decoder module 124 reconstructs the chroma current block based on the chroma prediction model of the chroma current block.

The reconstruction of the chroma current block at block 550 may be identical to the reconstruction of the chroma current block at block 360. In addition, the first chroma predicted block generated at block 550 by predicting the chroma current block based on the chroma prediction model of the chroma current block is determined based on the chroma block vector. The method/process 500 may then end.

When at least one of the methods/processes 300 and 500, and any other chroma decoding method including deriving a chroma prediction model of a chroma current block based on the chroma reference block indicated by a chroma block vector is performed by an electronic device using the configurations illustrated in FIGS. 1 and 2, the decoder module 124 may determine, from the video data, a syntax element indicating whether the chroma current block is reconstructed based on the chroma prediction model of the chroma current block derived based on one of the chroma block vector and a luma block vector. In some implementations, the syntax element may be a block vector prediction model flag, e.g., a BVLM flag. When the syntax element for the block vector prediction model is equal to one, one of the methods/processes 300 and 500, and any other chroma decoding method may be applied on the chroma current block. When the syntax element for the block vector prediction model is equal to zero, the methods/processes 300 and 500, and any other chroma decoding method may not be applied on the chroma current block.

The decoder module 124 may further determine whether a tree type of the chroma current block is a dual tree. In some implementations, when the tree type of the chroma current block is the dual tree, the decoder module 124 may determine the syntax element indicating whether the chroma current block is reconstructed based on the chroma prediction model of the chroma current block derived based on one of the chroma block vector and a luma block vector. When the tree type of the chroma current block is not the dual tree, the decoder module 124 may ignore to determine the syntax element from the video data. In some other implementations, when the tree type of the chroma current block is a single tree, the decoder module 124 may determine the syntax element indicating whether the chroma current block is reconstructed based on the chroma prediction model of the chroma current block derived based on one of the chroma block vector and a luma block vector. When the tree type of the chroma current block is not the single tree, the decoder module 124 may ignore to determine the syntax element from the video data. In some implementations, when the syntax element for the block vector prediction model is not parsed, the syntax element for the block vector prediction model may be inferred to zero.

The decoder module 124 may further determine whether a slice type of a slice including the chroma current block is an I-slice type. In some implementations, when slice tree type of the chroma current block is the I-slice type, the decoder module 124 may determine the syntax element indicating whether the chroma current block is reconstructed based on the chroma prediction model of the chroma current block derived based on one of the chroma block vector and a luma block vector. When the slice type of the chroma current block is not the I-slice type (e.g., a B-slice type and a P-slice type), the decoder module 124 may ignore to determine the syntax element from the video data. When the syntax element for the block vector prediction model is not parsed, the syntax element for the block vector prediction model may be inferred to zero.

The decoder module 124 may further determine a direct mode (DM) flag indicating whether the direct mode is applied on the chroma current block. In some implementations, when the DM flag of the chroma current block indicates that the direct mode is applied, the decoder module 124 may further determine the syntax element indicating whether the chroma current block is reconstructed based on the chroma prediction model of the chroma current block derived based on one of the chroma block vector and a luma block vector. When the direct mode is applied and the syntax element for the block vector prediction model is equal to one, the block vector prediction model is applied on the chroma current block. When the direct mode is applied and the syntax element for the block vector prediction model is equal to zero, the direct mode is applied on the chroma current block. Furthermore, when the DM flag of the chroma current block indicates that the direct mode is not applied, the decoder module 124 may ignore to determine the syntax element from the video data. In some implementations, when the DM flag of the chroma current block indicates that the direct mode is applied and a prediction mode of the luma corresponding block is associated with the block vector (e.g., the intraTMP mode, the IBC mode, and any other block-vector-related mode), the decoder module 124 may ignore to determine the syntax element from the video data and the syntax element for the block vector prediction model may be inferred to be equal to one.

The decoder module 124 may further determine a direct block vector (DBV) flag indicating whether the DBV mode is applied on the chroma current block. In some implementations, when the DBV flag of the chroma current block indicates that the DBV mode is applied, the decoder module 124 may determine the syntax element indicating whether the chroma current block is reconstructed based on the chroma prediction model of the chroma current block derived based on one of the chroma block vector and a luma block vector. When the DBV mode is applied and the syntax element for the block vector prediction model is equal to one, the block vector prediction model is applied on the chroma current block. When the DBV mode is applied and the syntax element for the block vector prediction model is equal to zero, the DBV mode is applied on the chroma current block. Furthermore, when the DBV flag of the chroma current block indicates that the DBV mode is not applied, the decoder module 124 may ignore to determine the syntax element from the video data. In some implementations, when the DBV flag of the chroma current block indicates that the direct mode is applied and a prediction mode of the luma corresponding block is associated with the block vector (e.g., the intraTMP mode, the IBC mode, and any other block-vector-related mode), the decoder module 124 may ignore to determine the syntax element from the video data and the syntax element for the block vector prediction model may be inferred to be equal to one.

In some implementations, when the tree type is the single tree, the luma corresponding block may be collocated with the chroma current block. In addition, when the tree type is the dual tree, a luma partitioning structure may be different from a chroma partitioning structure. Thus, the luma corresponding block may include one of multiple luma positions, e.g., a top-left corner, a top-right corner, a bottom-left corner, a bottom-right corner, and a central point of the luma current block.

The decoder module 124 may further determine a linear model flag (e.g., an isLM flag) indicating whether the CCLM mode is applied on the chroma current block. In some implementations, when the linear model flag of the chroma current block indicates that the CCLM mode is applied, the decoder module 124 may determine the syntax element indicating whether the chroma current block is reconstructed based on the chroma prediction model of the chroma current block derived based on one of the chroma block vector and a luma block vector. When the CCLM mode is applied and the syntax element for the block vector prediction model is equal to one, the block vector prediction model is applied on the chroma current block. When the DBV mode is applied and the syntax element for the block vector prediction model is equal to zero, the CCLM mode is applied on the chroma current block. Furthermore, when the isLM flag of the chroma current block indicates that the CCLM is not applied, the decoder module 124 may ignore to determine the syntax element from the video data.

The decoder module 124 may further determine a CCLM index (e.g., a cclm_idx) indicating whether the CCLM mode is applied on the chroma current block. In some implementations, when the CCLM index indicates one kind of the CCLM mode is applied, the decoder module 124 may determine the syntax element indicating whether the chroma current block is reconstructed based on the chroma prediction model of the chroma current block derived based on one of the chroma block vector and a luma block vector.

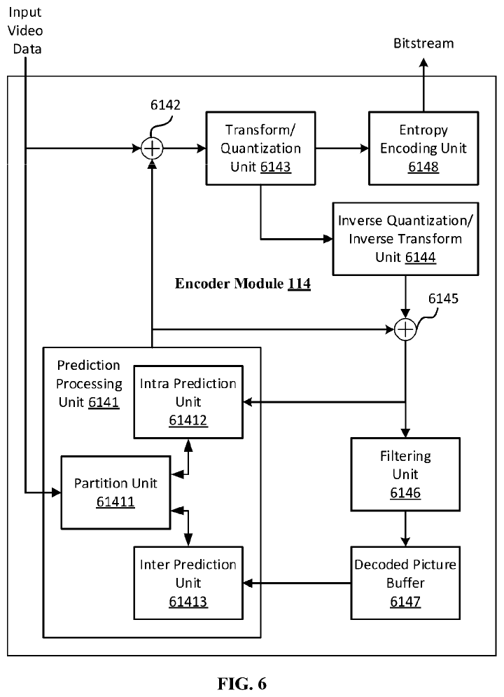

FIG. 6 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 6141), at least a first summer (e.g., a first summer 6142) and a second summer (e.g., a second summer 6145), a transform/quantization processor (e.g., a transform/quantization unit 6143), an inverse quantization/inverse transform processor (e.g., an inverse quantization/inverse transform unit 6144), a filter (e.g., a filtering unit 6146), a decoded picture buffer (e.g., a decoded picture buffer 6147), and an entropy encoder (e.g., an entropy encoding unit 6148). The prediction processing unit 6141 of the encoder module 114 may further include a partition processor (e.g., a partition unit 61411), an intra prediction processor (e.g., an intra prediction unit 61412), and an inter prediction processor (e.g., an inter prediction unit 61413). The encoder module 114 may receive the source video and encode the source video to output a bitstream.

The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 6141 may receive a current image block of a specific one of the image frames. The current image block may be the luminance block or one of the chrominance blocks in the specific image frame.

The partition unit 61411 may divide the current image block into multiple block units. The intra prediction unit 61412 may perform intra-predictive coding of a current block unit relative to one or more neighboring blocks in the same frame as the current block unit in order to provide spatial prediction. The inter prediction unit 61413 may perform inter-predictive coding of the current block unit relative to one or more blocks in one or more reference image blocks to provide temporal prediction.

The prediction processing unit 6141 may select one of the coding results generated by the intra prediction unit 61412 and the inter prediction unit 61413 based on a mode selection method, such as a cost function. The mode selection method may be a rate-distortion optimization (RDO) process.

The prediction processing unit 6141 may determine the selected coding result and provide a predicted block corresponding to the selected coding result to the first summer 6142 for generating a residual block and to the second summer 6145 for reconstructing the encoded block unit. The prediction processing unit 6141 may further provide syntax elements, such as motion vectors, intra-mode indicators, partition information, and/or other syntax information, to the entropy encoding unit 6148.

The intra prediction unit 61412 may intra-predict the current block unit. The intra prediction unit 61412 may determine an intra prediction mode directed toward a reconstructed sample neighboring the current block unit in order to encode the current block unit.

The intra prediction unit 61412 may encode the current block unit using various intra prediction modes. The intra prediction unit 61412 of the prediction processing unit 6141 may select an appropriate intra prediction mode from the selected modes. The intra prediction unit 61412 may encode the current block unit using a cross-component prediction mode to predict one of the two chroma components of the current block unit based on the luma components of the current block unit. The intra prediction unit 61412 may predict a first one of the two chroma components of the current block unit based on the second of the two chroma components of the current block unit.

The inter prediction unit 61413 may inter-predict the current block unit as an alternative to the intra prediction performed by the intra prediction unit 61412. The inter prediction unit 61413 may perform motion estimation to estimate motion of the current block unit for generating a motion vector.

The motion vector may indicate a displacement of the current block unit within the current image block relative to a reference block unit within a reference image block. The inter prediction unit 61413 may receive at least one reference image block stored in the decoded picture buffer 6147 and estimate the motion based on the received reference image blocks to generate the motion vector.

The first summer 6142 may generate the residual block by subtracting the prediction block determined by the prediction processing unit 6141 from the original current block unit. The first summer 6142 may represent the component or components that perform this subtraction.

The transform/quantization unit 6143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 6143 may perform a scan of the matrix including the quantized transform coefficients. Alternatively, the entropy encoding unit 6148 may perform the scan.

The entropy encoding unit 6148 may receive multiple syntax elements from the prediction processing unit 6141 and the transform/quantization unit 6143, including a quantization parameter, transform data, motion vectors, intra modes, partition information, and/or other syntax information. The entropy encoding unit 6148 may encode the syntax elements into the bitstream. The entropy encoding unit 6148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 6144 may apply inverse quantization and inverse transformation to reconstruct the residual block in the pixel domain for later use as a reference block. The second summer 6145 may add the reconstructed residual block to the prediction block provided by the prediction processing unit 6141 in order to produce a reconstructed block for storage in the decoded picture buffer 6147.

The filtering unit 6146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 6145.

The decoded picture buffer 6147 may be a reference picture memory that stores the reference block to be used by the encoder module 614 to encode video, such as in intra-coding or inter-coding modes. The decoded picture buffer 6147 may include a variety of memory devices, such as DRAM (e.g., including SDRAM), MRAM, RRAM, or other types of memory devices. The decoded picture buffer 6147 may be on-chip with other components of the encoder module 114 or off-chip relative to those components.

The method/process 300 for decoding and/or encoding video data may be performed by the first electronic device 110. With reference to FIGS. 1, 3, and 6, at block 310, the method/process 300 may start by the encoder module 114 receiving the video data. The video data received by the encoder module 114 may be a video. At block 320, the encoder module 114 determines a chroma current block from a current frame included in the video data. The encoder module 114 may divide the current frame to generate multiple CTUs, and further divide one of the CTUs to determine the block unit including the chroma current block and a luma current block according to the partition indications based on any video coding standard.

At block 330, the encoder module 114 determines a luma corresponding block reconstructed based on a luma reference block. The encoder module 114 may determine the luma current block collocated with the chroma current block, and then determine the luma corresponding block based on the luma current block collocated with the chroma current block.

At block 340, the encoder module 114 determines a chroma reference block based on a luma block vector of the luma corresponding block. The encoder module 114 may determine the luma block vector of the luma corresponding block for determining the luma reference block. Then, the encoder module 114 may determine the chroma block vector of the chroma current block based on the luma block vector for determining the chroma reference block.

At block 350, the encoder module 114 may derives a chroma prediction model of the chroma current block based on the chroma reference block. In some implementations, the encoder module 114 may determine a chroma reference region based on the chroma reference block, and determine a luma reference region based on the luma reference block. Then, the encoder module 114 may derive the chroma prediction model of the chroma current block based on the chroma reference region and the luma reference region. In some other implementations, the encoder module 114 may determine the chroma reference region based on the chroma reference block, and determine a chroma current region based on the chroma current block. Then, the encoder module 114 may derive the chroma prediction model of the chroma current block based on the chroma reference region and the chroma current region.

At block 360, the encoder module 114 reconstructs the chroma current block based on the chroma prediction model of the chroma current block. The encoder module 114 may predict the chroma current block to generate the chroma prediction block of the chroma current block based on the chroma prediction model of the chroma current block.

When the block unit is predicted by the encoder module 114, the encoder module 114 may predict the chroma current block based on other prediction modes to generate multiple chroma predicted results. The encoder module 114 may select one of the chroma prediction block and the chroma predicted results based on a mode selection method, such as a cost function. The mode selection method may be a rate-distortion optimization (RDO) process. The encoder module 114 may provide the selected coding result to the first summer 6142 for generating a residual block and to the second summer 6145 for reconstructing the encoded block unit. The encoder module 114 may further provide syntax elements, such as motion vectors, intra-mode indicators, partition information, and/or other syntax information, to the entropy encoding unit 6148.

The reconstruction of the chroma current block at blocks 330-350 by the encoder module 114 may be identical to the reconstruction of the chroma current block at blocks 330-350 by the decoder module 124. The reconstruction of the chroma current block at block 360 by the decoder module 124 may be also performed at block 360 by the encoder module 114. The method/process 300 for the encoder module 114 may then end.

The method/process 500 for decoding and/or encoding video data may be performed by the first electronic device 110. With reference to FIGS. 1, 5, and 6, at block 510, the method/process 500 may start by the encoder module 114 receiving the video data. The video data received by the encoder module 114 may be a video. At block 520, the encoder module 114 determines a chroma current block from a current frame included in the video data. The encoder module 114 may divide the current frame to generate multiple CTUs, and further divide one of the CTUs to determine the block unit including the chroma current block and a luma current block according to the partition indications based on any video coding standard.

At block 530, the encoder module 114 determines, from the current frame, a chroma reference block indicated by a chroma block vector of the chroma current block. The chroma block vector of the chroma current block may be determined using an intra template matching prediction (intraTMP) mode to indicate the chroma reference block without parsing a vector syntax.

At block 540, the encoder module 114 may derives a chroma prediction model of the chroma current block based on the chroma reference block. In some implementations, the encoder module 114 may determine a chroma reference region based on the chroma reference block, and determine a luma reference region based on the luma reference block. Then, the encoder module 114 may derive the chroma prediction model of the chroma current block based on the chroma reference region and the luma reference region. In some other implementations, the encoder module 114 may determine the chroma reference region based on the chroma reference block, and determine a chroma current region based on the chroma current block. Then, the encoder module 114 may derive the chroma prediction model of the chroma current block based on the chroma reference region and the chroma current region.

At block 550, the encoder module 114 reconstructs the chroma current block based on the chroma prediction model of the chroma current block. The encoder module 114 may predict the chroma current block to generate the chroma prediction block of the chroma current block based on the chroma prediction model of the chroma current block.

When the block unit is predicted by the encoder module 114, the encoder module 114 may predict the chroma current block based on other prediction modes to generate multiple chroma predicted results. The encoder module 114 may select one of the chroma prediction block and the chroma predicted results based on a mode selection method, such as a cost function. The mode selection method may be a rate-distortion optimization (RDO) process. The encoder module 114 may provide the selected coding result to the first summer 6142 for generating a residual block and to the second summer 6145 for reconstructing the encoded block unit. The encoder module 114 may further provide syntax elements, such as motion vectors, intra-mode indicators, partition information, and/or other syntax information, to the entropy encoding unit 6148.

The reconstruction of the chroma current block at blocks 530- and 540 by the encoder module 114 may be identical to the reconstruction of the chroma current block at blocks 530 and 540 by the decoder module 124. The reconstruction of the chroma current block at block 550 by the decoder module 124 may be also performed at block 550 by the encoder module 114. The method/process 500 for the encoder module 114 may then end.

When at least one of the methods/processes 300 and 500, and any other chroma encoding/decoding method including deriving a chroma prediction model of a chroma current block based on the chroma reference block indicated by a chroma block vector is performed by an electronic device using the configurations illustrated in FIGS. 1 and 6, the encoder module 114 may signal, into a bitstream, a syntax element indicating whether the chroma current block is reconstructed based on the chroma prediction model of the chroma current block derived based on one of the chroma block vector and a luma block vector. In some implementations, the syntax element may be a block vector prediction model flag, e.g., a BVLM flag. When the syntax element for the block vector prediction model is equal to one, one of the methods/processes 300 and 500, and any other chroma decoding method may be applied on the chroma current block. When the syntax element for the block vector prediction model is equal to zero, the methods/processes 300 and 500, and any other chroma decoding method may not be applied on the chroma current block.

The encoder module 114 may further signal a tree type syntax element indicating whether a tree type of the chroma current block is a dual tree. In some implementations, when the tree type of the chroma current block is the dual tree, the encoder module 114 may signal, into the bitstream, the syntax element indicating whether the chroma current block is reconstructed based on the chroma prediction model of the chroma current block derived based on one of the chroma block vector and a luma block vector. When the tree type of the chroma current block is not the dual tree, the encoder module 114 may determine not to signal the syntax element into the bitstream. In some other implementations, when the tree type of the chroma current block is a single tree, the encoder module 114 may signal, into the bitstream, the syntax element indicating whether the chroma current block is reconstructed based on the chroma prediction model of the chroma current block derived based on one of the chroma block vector and a luma block vector. When the tree type of the chroma current block is not the single tree, the encoder module 114 may determine not to signal the syntax element into the bitstream. In some implementations, when the syntax element for the block vector prediction model is not signaled into the bitstream, the syntax element for the block vector prediction model may be inferred to zero.

The encoder module 114 may further signal a slice type syntax element indicating whether a slice type of a slice including the chroma current block is an I-slice type. In some implementations, when slice tree type of the chroma current block is the I-slice type, the encoder module 114 may signal the syntax element indicating whether the chroma current block is reconstructed based on the chroma prediction model of the chroma current block derived based on one of the chroma block vector and a luma block vector. When the slice type of the chroma current block is not the I-slice type (e.g., a B-slice type and a P-slice type), the encoder module 114 may determine not to signal the syntax element into the bitstream. When the syntax element for the block vector prediction model is not signaled into the bitstream, the syntax element for the block vector prediction model may be inferred to zero.

The encoder module 114 may further signal a direct mode (DM) flag indicating whether the direct mode is applied on the chroma current block. In some implementations, when the DM flag of the chroma current block indicates that the direct mode is applied, the encoder module 114 may further signal the syntax element indicating whether the chroma current block is reconstructed based on the chroma prediction model of the chroma current block derived based on one of the chroma block vector and a luma block vector. When the direct mode is applied and the syntax element for the block vector prediction model is equal to one, the block vector prediction model is applied on the chroma current block. When the direct mode is applied and the syntax element for the block vector prediction model is equal to zero, the direct mode is applied on the chroma current block. Furthermore, when the DM flag of the chroma current block indicates that the direct mode is not applied, the encoder module 114 may determine not to signal the syntax element into the bitstream. In some implementations, when the DM flag of the chroma current block indicates that the direct mode is applied and a prediction mode of the luma corresponding block is associated with the block vector (e.g., the intraTMP mode, the IBC mode, and any other block-vector-related mode), the encoder module 114 may determine not to signal the syntax element into the bitstream and the syntax element for the block vector prediction model may be inferred to be equal to one.

The encoder module 114 may further signal a direct block vector (DBV) flag indicating whether the DBV mode is applied on the chroma current block. In some implementations, when the DBV flag of the chroma current block indicates that the DBV mode is applied, the encoder module 114 may signal the syntax element indicating whether the chroma current block is reconstructed based on the chroma prediction model of the chroma current block derived based on one of the chroma block vector and a luma block vector. When the DBV mode is applied and the syntax element for the block vector prediction model is equal to one, the block vector prediction model is applied on the chroma current block. When the DBV mode is applied and the syntax element for the block vector prediction model is equal to zero, the DBV mode is applied on the chroma current block. Furthermore, when the DBV flag of the chroma current block indicates that the DBV mode is not applied, the encoder module 114 may determine not to signal the syntax element into the block unit. In some implementations, when the DBV flag of the chroma current block indicates that the direct mode is applied and a prediction mode of the luma corresponding block is associated with the block vector (e.g., the intraTMP mode, the IBC mode, and any other block-vector-related mode), the encoder module 114 may determine not signal the syntax element into the bitstream and the syntax element for the block vector prediction model may be inferred to be equal to one.

In some implementations, when the tree type is the single tree, the luma corresponding block may be collocated with the chroma current block. In addition, when the tree type is the dual tree, a luma partitioning structure may be different from a chroma partitioning structure. Thus, the luma corresponding block may include one of multiple luma positions, e.g., a top-left corner, a top-right corner, a bottom-left corner, a bottom-right corner, and a central point of the luma current block.

The encoder module 114 may further signal a linear model flag (e.g., an isLM flag) indicating whether the CCLM mode is applied on the chroma current block. In some implementations, when the linear model flag of the chroma current block indicates that the CCLM mode is applied, the encoder module 114 may signal the syntax element indicating whether the chroma current block is reconstructed based on the chroma prediction model of the chroma current block derived based on one of the chroma block vector and a luma block vector. When the CCLM mode is applied and the syntax element for the block vector prediction model is equal to one, the block vector prediction model is applied on the chroma current block. When the DBV mode is applied and the syntax element for the block vector prediction model is equal to zero, the CCLM mode is applied on the chroma current block. Furthermore, when the isLM flag of the chroma current block indicates that the CCLM is not applied, the encoder module 114 may determine not to signal the syntax element into the bitstream.

The encoder module 114 may further signal a CCLM index (e.g., a cclm_idx) indicating whether the CCLM mode is applied on the chroma current block. In some implementations, when the CCLM index indicates one kind of the CCLM mode is applied, the encoder module 114 may signal the syntax element indicating whether the chroma current block is reconstructed based on the chroma prediction model of the chroma current block derived based on one of the chroma block vector and a luma block vector.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a chroma current block from a current frame included in the video data;
determine a luma corresponding block reconstructed based on a luma reference block, wherein:
the luma corresponding block and the luma reference block are included in the current frame and are reconstructed prior to reconstructing the chroma current block, and
the luma corresponding block is determined based on a luma current block collocated with the chroma current block;
determine a chroma reference block based on a luma block vector of the luma corresponding block, wherein the luma block vector of the luma corresponding block is directed from the luma corresponding block towards the luma reference block;
derive a chroma prediction model of the chroma current block based on the chroma reference block; and
reconstruct the chroma current block based on the chroma prediction model of the chroma current block.

2. The non-transitory machine-readable medium of claim 1, wherein:
the luma corresponding block is one of the luma current block and a luma neighboring block neighboring the luma current block.

3. The non-transitory machine-readable medium of claim 1, wherein:
the luma block vector of the luma corresponding block is determined using one of an intra block copy (IBC) mode and an intra template matching prediction (intraTMP) mode to indicate the luma reference block for reconstructing the luma corresponding block.

4. The non-transitory machine-readable medium of claim 1, wherein the one or more computer-executable instructions, when executed by at least one processor of the electronic device, further cause the electronic device to:
determine a chroma reference region based on the chroma reference block;
determine a luma reference region based on the luma reference block; and
derive the chroma prediction model of the chroma current block based on the chroma reference region and the luma reference region, wherein the chroma current block is reconstructed based on the luma corresponding block and the chroma prediction model of the chroma current block.

5. The non-transitory machine-readable medium of claim 1, wherein:
the chroma prediction model of the chroma current block is determined using one of a plurality of intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode.

6. The non-transitory machine-readable medium of claim 1, wherein:
the chroma prediction model of the chroma current block is identical to a chroma reference model of the chroma reference block when chroma reference block is reconstructed based on the chroma reference model, and
the chroma reference model of the chroma current block is determined using one of a plurality of intra prediction model modes including a CCLM mode, a MMLM mode, a CCCM mode, a GLM mode, and a slope adjustment of a linear model mode.

7. The non-transitory machine-readable medium of claim 1, wherein the one or more computer-executable instructions, when executed by at least one processor of the electronic device, further cause the electronic device to:
determine a chroma reference region based on the chroma reference block; and
determine a chroma current region based on the chroma current block, wherein:
deriving the chroma prediction model of the chroma current block comprises deriving the chroma prediction model of the chroma current block based on the chroma reference region and the chroma current region, and
reconstructing the chroma current block comprises reconstructing the chroma current block based on the chroma reference block and the chroma prediction model of the chroma current block.

8. The non-transitory machine-readable medium of claim 1, wherein the one or more computer-executable instructions, when executed by at least one processor of the electronic device, further cause the electronic device to:
predict the chroma current block based on the chroma prediction model of the chroma current block to generate a first chroma predicted block determined based on the luma block vector;
predict the chroma current block further based on one of a plurality of intra prediction modes other than a plurality of intra prediction model modes to generate a second chroma predicted block; and
weightedly combine the first chroma predicted block and the second chroma predicted block to generate a chroma prediction block of the chroma current block, wherein
reconstructing the chroma current block comprises reconstructing the chroma current block based on the chroma prediction block of the chroma current block.

9. The non-transitory machine-readable medium of claim 8, wherein:
the plurality of intra prediction modes other than the plurality of intra prediction model modes includes a direct block vector (DBV) mode, a direct current (DC) mode, a Planar mode, and a plurality of intra angular modes.

10. The non-transitory machine-readable medium of claim 1, wherein:
the chroma prediction model of the chroma current block is adjusted by at least one of a plurality of adjustment parameters before reconstructing the chroma current block.

11. The non-transitory machine-readable medium of claim 1, wherein the one or more computer-executable instructions, when executed by at least one processor of the electronic device, further cause the electronic device to:
determine whether a tree type of the chroma current block is a dual tree;
when the tree type of the chroma current block is the dual tree, determine, from the video data, a syntax element indicating whether the chroma current block is reconstructed based on the chroma prediction model of the chroma current block derived based on the luma block vector; and
when the tree type of the chroma current block is not the dual tree, ignore determining the syntax element from the video data.

12. The non-transitory machine-readable medium of claim 1, wherein the one or more computer-executable instructions, when executed by at least one processor of the electronic device, further cause the electronic device to:
determine whether a slice type of the chroma current block is an I-slice type;
when the slice type of the chroma current block is the I-slice type, determine, from the video data, a syntax element indicating whether the chroma current block is reconstructed based on the chroma prediction model of the chroma current block derived based on the luma block vector; and
when the slice type of the chroma current block is not the I-slice type, ignore determining the syntax element from the video data.

13. An electronic device for decoding video data, the electronic device comprising:
one or more processors; and
one or more non-transitory computer-readable media coupled to the one or more processors and storing one or more computer-executable instructions that, when executed by at least one of the one or more processors, cause the electronic device to:
receive the video data;
determine a chroma current block from a current frame included in the video data;
determine a luma corresponding block reconstructed based on a luma reference block, wherein:
the luma corresponding block and the luma reference block are included in the current frame and are reconstructed prior to reconstructing the chroma current block, and
the luma corresponding block is determined based on a luma current block collocated with the chroma current block;
determine a chroma reference block based on a luma block vector of the luma corresponding block, wherein the luma block vector of the luma corresponding block is directed from the luma corresponding block towards the luma reference block;
derive a chroma prediction model of the chroma current block based on the chroma reference block; and
reconstruct the chroma current block based on the chroma prediction model of the chroma current block.

14-26. (canceled)

27. The electronic device of claim 13, wherein:
the luma block vector of the luma corresponding block is determined using one of an intra block copy (IBC) mode and an intra template matching prediction (intraTMP) mode to indicate the luma reference block for reconstructing the luma corresponding block.

28. The electronic device of claim 13, wherein the one or more computer-executable instructions, when executed by at least one processor of the electronic device, further cause the electronic device to:
determine a chroma reference region based on the chroma reference block;
determine a luma reference region based on the luma reference block; and
derive the chroma prediction model of the chroma current block based on the chroma reference region and the luma reference region, wherein the chroma current block is reconstructed based on the luma corresponding block and the chroma prediction model of the chroma current block.

29. The electronic device of claim 13, wherein:
the chroma prediction model of the chroma current block is determined using one of a plurality of intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode.

30. An electronic device for encoding video data, the electronic device comprising:
one or more processors; and
one or more non-transitory computer-readable media coupled to the one or more processors and storing one or more computer-executable instructions that, when executed by at least one of the one or more processors, cause the electronic device to:
receive the video data;
determine a chroma current block from a current frame included in the video data;
determine a luma corresponding block reconstructed based on a luma reference block, wherein:
the luma corresponding block and the luma reference block are included in the current frame and are reconstructed prior to reconstructing the chroma current block, and
the luma corresponding block is determined based on a luma current block collocated with the chroma current block;
determine a chroma reference block based on a luma block vector of the luma corresponding block, wherein the luma block vector of the luma corresponding block is directed from the luma corresponding block towards the luma reference block;
derive a chroma prediction model of the chroma current block based on the chroma reference block; and
reconstruct the chroma current block based on the chroma prediction model of the chroma current block.

31. The electronic device of claim 30, wherein:
the luma block vector of the luma corresponding block is determined using one of an intra block copy (IBC) mode and an intra template matching prediction (intraTMP) mode to indicate the luma reference block for reconstructing the luma corresponding block.

32. The electronic device of claim 30, wherein the one or more computer-executable instructions, when executed by at least one processor of the electronic device, further cause the electronic device to:
determine a chroma reference region based on the chroma reference block;
determine a luma reference region based on the luma reference block; and
derive the chroma prediction model of the chroma current block based on the chroma reference region and the luma reference region, wherein the chroma current block is reconstructed based on the luma corresponding block and the chroma prediction model of the chroma current block.

33. The electronic device of claim 30, wherein:
the chroma prediction model of the chroma current block is determined using one of a plurality of intra prediction model modes including a cross-component linear model (CCLM) mode, a multi-model linear model (MMLM) mode, a convolutional cross-component intra prediction model (CCCM) mode, a gradient linear model (GLM) mode, and a slope adjustment of a linear model mode.
